(19) United States
(12) Patent Application Publication
(10) Pub. No.: US 2011/0166905 A1
(43) Pub. Date: Jul. 7, 2011

(54) METHOD OF PROCUREMENT

(75) Inventor: Keith Gregory Wright, Eumundi, Oueensland (AU)

(73) Assignee: ARCTURUS INNOVATIVE PROCUREMENT SOUTIONS PTY LTD., Eumundi, Oueensland (AU)

(21) Appl. No.: 12/994,074

(22) PCT Filed: May 8, 2009
(86) PCT No.: PCT/AU2009/000580

§ 371 Date: Nov. 22, 2010

(30) Foreign Application Priority Data
May 23, 2008 (AU) 2008902576

(51) Int. Cl. G06Q 10/00; G06Q 30/00

(52) U.S. Cl. 705/7.23; 705/1.1

(57) ABSTRACT

A method of procurement in the program planning procurement stage of a project by a project partner for a procurement Client including the steps of: establishing a no scope, no value contract arrangement between the procurement Client and the project partner; provision of resources by the project partner for the planning procurement stage under the no value arrangement; engaging the project partner in the program planning stage, and upon the execution of a project order, conferring full responsibility for delivery of goods and services to the project partner.

This invention relates to a method of procurement. The invention has particular application to procurement of infrastructure assets by government. However, the invention is not limited to this field of use.

Procurement by government agencies normally involves a time consuming and costly process which may be broken down to nine steps and referred to as such herein for convenience. For example, a typical procurement process includes as a first step an assessment of a need by the client—that is, the government agency—followed by a feasibility study to determine the scope of works and the value of same as a second step. The feasibility study is normally followed by third step comprising a concept design. These first three steps are usually carried out by the government agencies, although it is possible for one or more of these steps to be outsourced.

The fourth step comprises the calling for expressions of interest from those having an interest in providing the asset to be procured. The fifth step normally involves a tendering process where a number of bidders may tender to provide the asset at a proposed price. The successful tenderer (if any) is selected in the sixth step of the process, followed by execution of a contract, delivery of the asset to be procured and handover of same forming the seventh to ninth steps respectively.

In some instances, a practice has developed under the above described process to establish what may be referred to as “pure alliances” between government agencies and their suppliers. In instances where there has been a heavy demand in respect of procurement, significant escalations in cost, completion timeframes or both have been experienced. The traditional approach requires the establishment of the scope of works and the application of a value of such works.

The present invention is aimed at providing a less costly alternative which is especially applicable for procurement of infrastructure by government.

With the foregoing in view, in a first aspect, the invention resides broadly in a method of procurement for a procurement Client including the steps of:

assessing one or more needs whereby a supply is to be procured on behalf of the procurement Client;

tendering for satisfaction of the supply for a predetermined proportion or margin of a figure associated with the supply by one or more project partners; and

selecting the project partner for procuring the supply on behalf of the procurement Client as a selected project partner; and

having the selected project partner, manage the steps necessary for completion of the procurement of the supply for delivery and/or handover to the procurement Client.

In a second aspect, the invention resides broadly in a method of procurement for a procurement Client including the steps of:

assessing one or more needs whereby a supply is to be procured on behalf of the procurement Client;

tendering for satisfaction of the supply for a predetermined proportion or margin of a figure associated with the supply by one or more project partners;

contracting one or more of the project partner for procuring the supply on behalf of the procurement Client as a selected project partner with a contract having no scope and no value; and

having the selected project partner, manage the steps necessary for completion of the procurement of the supply for delivery and/or handover to the procurement Client.

In a third aspect, the invention resides broadly in a method of procurement in the program planning procurement stage by a project partner for a procurement Client including the steps of:

establishing a no scope, no value contract arrangement between the procurement Client and the project partner;

provision of resources by the project partner for the planning procurement stage under the no value arrangement;

engaging the project partner in the program planning stage, and

upon the execution of a project order, conferring full responsibility for delivery of goods and services to the project partner.

Advantageously, the method or procurement according to the invention avoids the existing system whereby costs associated with the tendering process are accumulated for recovery at a later date by unsuccessful tenderers. Because the method of procurement according to the present invention includes an early tendering process, and for a different remuneration paradigm, such costs are either eliminated altogether, or moved into the supply in satisfaction of the one or more needs later in the method by costing of work orders, or apportioned across the whole job or the like even though the one or more needs may be assessed at the beginning of the process.

The assessing of the one or more needs may be carried out by the procurement Client. The method may include the completion of a feasibility study prior to tendering. The method may further include completion of a concept design step prior to tendering. The feasibility study and concept design steps may be completed by the procurement Client or the project partner, or may be outsourced by either or any of them. Preferably, the proportion or Margin is assessed on the value of one or more work orders contracted by a contractor to the project partner. It will be appreciated that the supply procured on behalf of the procurement Client encompasses supply for the procurement Client.

Following the tendering for the supply, it is preferred that the project partner and procurement Client execute a contract. Preferably, the contract is not limited to procurement of a particular asset or asset or completion of a particular project, but instead is established for a predetermined timeframe. For example, the project partner winning the tender in accordance with the invention may be awarded a contract for a particular margin on works to be commenced within, say, a five-year timeframe. In such form, the method preferably includes that the margin awarded to the project partner in respect of work orders survive the predetermined timeframe to completion of the work orders.

In order that the invention may be more readily understood and put into practical effect, reference will now be made to the following drawings which illustrate a preferred embodiment of the invention and in which:

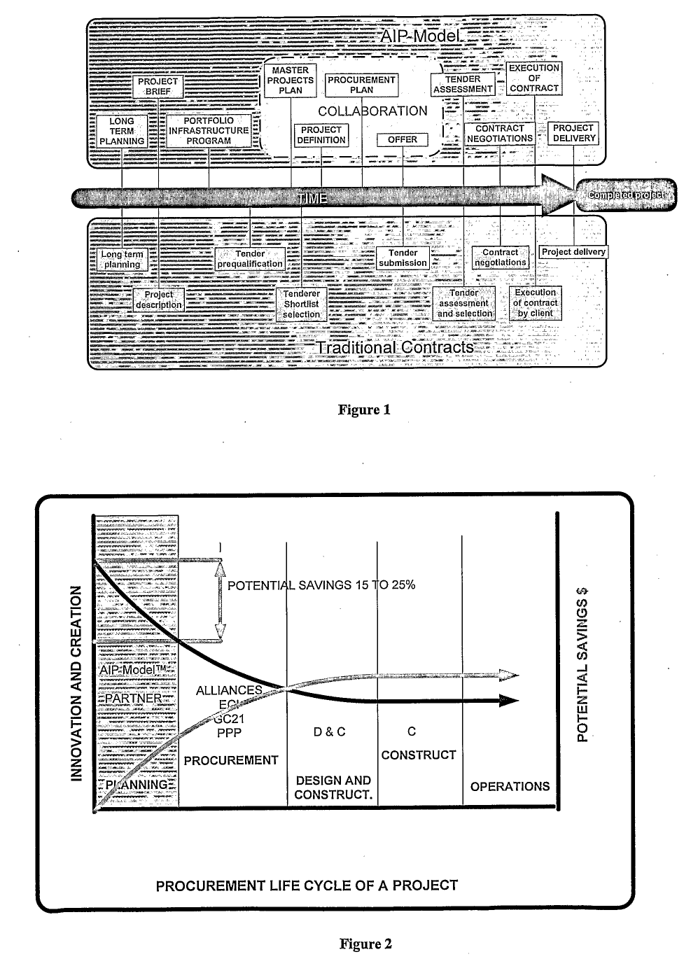

FIG. 1 is a project life-cycle diagram showing the position of the method of procurement;

FIG. 2 is a diagrammatic representation of a project timeline associated with two box diagrams of procurement methods for comparison of the method of the present invention with the traditional method of procurement;

FIG. 3 is a flowchart showing detail procurement method of FIG. 2 in more detail;

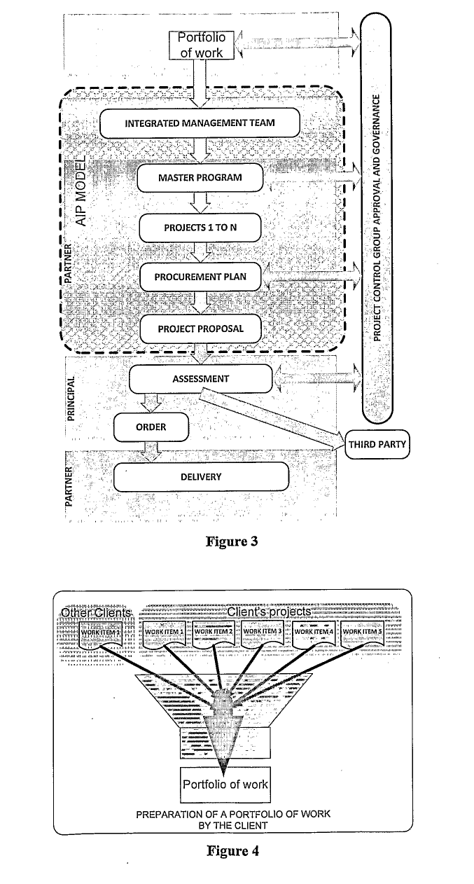

FIG. 4 is a pictorial diagram illustrating development of a portfolio of work; and

FIG. 6 is a management system diagram illustrating the flow of management information for implementation of the method according to the invention.

The project life-cycle diagram of FIG. 1 shows that the method of procurement of the present invention resides across the planning stage at the commencement of a project only. However, it will be appreciated that project completion would be affected by the adoption of the method of the invention in both cost and timeframe as a consequence of the improvements which accrue from the method.

As can be seen in the methods shown in the project timeline diagram of FIG. 2, and in more detail in the flowchart of FIG. 3, the method of the present invention, referred to as the AIP Model and described in more detail hereinafter, is distinct from the traditional method in the inclusion of a zone of collaboration indicated by the box with the broken-line border above the time line arrow. The traditional model does not have this feature. In this zone the client engages via a No Scope No Value Contract or head agreement, a partner to provide planning, estimating and tender administration resources necessary for project delivery. The partner agrees to provide these resources as an obligation arising out of the Head Agreement (HA) at no cost to the client.

At the end of the collaboration process for each particular project the partner submits an offer to the client for the work. This offer addresses all the client's needs and make a recommendation on how the works should be undertaken. This offer is assessed by the client and if the client is of the view that the proposal meets its requirements then the client will execute a project order with the partner for the delivery of the project.

The Partner's recovery of the resource costs shall be by way of a fee that is an amount agreed for the term of the contract usually a percent, which is applied to the project direct costs. If no orders are raised then no fees will be recovered. The responsibility to meet the client's need and provide quality work rests with the partner. The Partners that are successful in achieving this requirement will have a growing portfolio of infrastructure projects and profit margins that will satisfy their board and share holders.

It may be seen that the method of the present invention improves infrastructure delivery by the utilisation of a strategic planning tool which may be coupled with an e-commerce management system, preferably one which is designed to record all communication between the parties during projects planning and delivery phases, the method being referred to by the inventors as the Arcturus Innovative Planning (AIP) Model.

The strategic procurement process commences with the client adopting a strategic approach for the supply of goods and services associated with infrastructure planning and delivery. This strategic approach can be done in many ways but for the successful implementation of the AIP Model the client needs to engage a facilitator that is familiar with the AIP Model and strategic planning and management system (AIS).

As part of the implementation process the first job of the facilitator is to determine the client's needs and to establish a business Partner (not legal partner) who can meet these needs. The Partner's initial task is to provide all planning, tendering and estimating resources for portfolio program. The cost of providing these resources shall be recovered by the application of an agreed fee to future project orders and not as a cost under the HA.

In the set-up phase of the portfolio of works, the facilitator will assess the client's needs and then manages a selection process for the identification of a suitable partner or partners to assist in the role-out of the infrastructure portfolio. The decision on how many partners are chosen is a function of the diversity of goods and services in the portfolio and the preference of the client.

Following the selection of the Partner and the execution of the head agreement the program goes into the Operational Phase. In the operational phase the administrative responsibility and commercial arrangements for the facilitator expand.

The roles and responsibilities of the facilitator, client and partner for the Setup and Operations Phases of the HA may be divided between a Procurement Process, a Management System and Capital Funding. In the Operations phase the facilitator shall be the client's representatives on the Portfolio's Integrated Management Team (PIMT). The PIMT comprises two representatives from the client and two representatives from the partner who oversee the successful implementation of the AIP Model and AIS in the program.

The Partner shall execute a HA with the Client that has no scope and no value. In other words there is no promise or representation by the Client about the value of the work, the content of the Portfolio or the ultimate tenure of the HA. However, for the purpose of selecting a suitable partner, the type of work and the potential scope of the portfolio needs to be appreciated in order to identify and select a partner who has the financial capability and resource capacity to successfully undertake the planning and delivery tasks.

After the execution of the HA the type of work and the extent of the portfolio will be progressively agreed by the parties as the client's budgets are confirmed and portfolio information becomes available. This arrangement gives the client control of the portfolio's content and context in the light of their policy and legislature requirements, whilst the Partner establishes itself as the preferred contractor for any project delivery.

The Partner's status as the preferred contractor for the delivery of projects, arising out of the HA, does not guarantee any project orders. The client's decision to award project orders or not is subject to the performance of the partner, his ability to exceed expectations and the quality, of the offer in which he proposes to deliver the projects. Offers arising from the HA accepted by the Client shall be delivered via separate and individual project orders not as a variation to the HA.

The Partner's performance is measured in two ways. Firstly his ability to meet client's planning, tendering, estimating and administrative resource requirements by providing experienced and competent staff and secondly by the quality of the proposal for the delivery of infrastructure goods and services. If the client is happy with the partners performance the length of the agreement or tenure will be long, the probability or assurance of work going the partners way will be high and the agreed fee for corporate overheads and profit will be rewarding. The level of these fees, though competitively set, will become an incentive that will drive and motivate the partner to exceed client's expectations in order to grow the portfolio.

The pictorial diagram of FIG. 4 illustrates the development of a portfolio of works. The strategic procurement process commences with the decision of the client to implement a strategic planning and delivery approach to capital and operational works programming. This approach takes a holistic view of future works and seeks to realise benefits through project synergies and alignment with the help of an experienced partner. Identification of work items for capital or operational projects is essential.

The identification of elements of work or work items, note diagram below the “client's projects”, and the funnelling of these elements of work into a portfolio of work, is an important feature of the AIP Model's planning strategy and procurement process. The work items may be similar or of a diverse nature, from a single or multiple clients depending on the circumstances and legal provision. The portfolio of work enables the realisation of benefits through more effective combination of work items in the planning phase and efficiency gains from project synergies and economy of scale realised during the delivery phase.

Information on the work items comes from the client's corporate and business capital and operational expenditure program. The information provided on the work items is in the form of a project brief, which describes scope, specification and quality requirements. The purpose of the brief is to give the partner an insight into the client's needs and for these needs to be considered in future planning and delivery phases.

The Client may from time to time change the content of the portfolio of work by adding or removing work items. These changes will be in response to budget, priority or emergency needs of the capital and operational plans. As a requirement of the HA the partner accepts that these changes are to be expected and will take all necessary steps to ensure changes are effected without bias with respect to planning and procurement activities.

Employment of a facilitator follows the decision by the client to take a strategic procurement approach to delivery of a portfolio of works. The facilitator will set up the AIP Model and administer the process with the assistance of the client's resources. The first job of the facilitator will be to determine the needs of the client in order to determine the appropriate partner for this future relationship. The partner selection will be based on, their capability and capacity to exceed client's needs with respect to planning and delivery of goods and services.

The selection of the partner is managed by the facilitator in the form of a competitive tender. In order to attract suitable tenderers a general view is provided of the potential scope of work and value without this being a representation of the actual work. The tenderer's submissions are assessed on, financial capacity, past project experience, skill of resource team, capability and capacity. The selection process includes mandatory requirements, short listing and workshops designed to test the credibility of the proposed partner's resource team.

The execution of a head agreement with the preferred Partner is the end of the selection process. The head agreement is in the form of a deed in which the partner promise to provide a range of technical and management resources without the client promises of consideration. The work undertaken by the Partner arising from the HA is undertaken by the Partner with any charge to the client. All costs during the planning phase of the project are covered by the Partner's Corporate Overhead and Profit applied to future PO.

Arising out of the HA is the promise by the Partner to provide planning and procurement resources that will work with the client's resources for the portfolio planning and procurement processes. The management of these resources, their quality, type and number is the responsibility of the Partner, as a function of client needs. The team that is formed by the combination of the party's resources will actively develop a project charter, which will include the agreed project objects and goals and participants behaviour. The team will work collaboratively to achieve the HA outcomes.

Following the execution of the HA the first task of the Partner is the development of a Master Program (MP). The MP is the first opportunity for the partner to provide input into the portfolio's role out. To achieve this, the Partner will use market place knowledge and construction experience to review the content of the portfolio with the purpose of identifying project synergies. Flowing from this activity, project development milestones will be identified. The MP will become the guide for measuring team's performance during the planning and procurement phases. To accommodate change to the MA with the addition or removal of projects, the MP is dynamic being continuously upgraded to reflect project performance and changes to portfolio scope. The MA and all changes during implementation are subject to the approval of the client.

The partner on reviewing the project briefs provided by the client for the Portfolio of works will shape the project briefs by bundling or dissection into new project. The purpose of this exercise is to use the partner's market knowledge and construction experience to improve portfolio delivery effectiveness through project synergies. The new projects if different to original project brief will be returned to the client and if necessary new briefs prepared to reflect these changes. The projects will then become the basis for all future obligations of the partner.

The projects identified by the partner as part of the portfolio of works delivery shall have a procurement strategy plan. The strategy plan is designed to flesh out the partners preferred delivery approach with respect to meeting client's needs and contractual arrangements. This document is subject to the approval of the client and the guide for the future project proposal or offer for the particular project. The strategy plan is designed to provide a comprehensive look at how the partner intends to deliver the project.

If the partner wishes to undertake some of the work in the delivery of the project the extent needs to be spelt out in the Procurement Plan (PP). This work is self performance and may be limited to project management or as extensive as construction works. Either way the partner is not permitted to undertake any work in future orders, without the express permission of the client. This permission will not be unreasonably withheld however competitive tension in subcontractor pricing is essential for delivery success. If the client is of the view that the partners planned self performance activity is detrimental to this outcome he has the right to object and decline permission.

For each project the partner will, make a recommendation on of how the works should be executed. This recommendation is referred to as a project proposal or an offer. Each project identified by the partner as a project in the MP will have a matching PP or offer. The PP will be a comprehensive document in which all the principles of procurement will be addressed as well as the client's needs. The basis of the recommendation will be provided as supporting documentation.

The partner has the freedom to choose the type of contract he wants to use for project delivery. However this is conditional on the contract being in a form acceptable to the client. A copy of the contract will be provided with the PP signed by the Partner ready for the client's execution. As the contract can be of any type or size for the purpose of this document it is commonly referred to as a project order. This project order could be simple or complex however if there are to multiple orders for similar categories of work setting up a suite of standard contract is a likely outcome.

Gateway reviews are carried out by client on information provided by the partner at regular intervals during the planning phase. These gateway reviews are designed to keep the client informed of progress and to seek approval on the nature and type of contracts to be implemented during delivery. It is essential that the partner seek approval for the Master Plan initial and amendments, the Procurement Plan and the Project Proposal for each project in the portfolio of works. The client may delegate this authority to a single person or a control group.

A Portfolio administrative structure that is well arranged is important for governance and reporting purposes.

The parties need to know who has the authority to approve and who is responsible for project performance. Our structure includes two levels of authority in the planning phase. The lower level is the portfolio management team (PMT) or integrated management team and the upper level is the portfolio executive team both comprising an equal number of representatives from the parties.

The Project executive team has the responsibility for the overarching management of the planning phase with respect to the implementation of corporate policies and procedures, strategic planning and dispute resolution. The executive team members have authority to bind, however as the PET in the planning phase their role is limited to providing advice except when resolving disputes arising from the implementation of the HA. When resolving disputes the PET has the authority to decide and provided direction to the integrated management team. The PET established in the planning phase in accordance with the HA has no role or authority in the delivery phase. An exception to this would be where a Project order is raised and includes a structural arrangement to reflect a similar structural arrangement to the HA.

The Integrated Management Team (PMT) is the team tasked with the responsibility for receiving and managing all information entering the program and agreeing in principle all information leaving the program. The team is established immediately the HA is executed and stays in place until the HA comes to an end, completes all its tasks or the HA is terminated. The PMT comprises an equal number of representatives from the parties, which is designed to ensure good decision making dynamics. The team works collaboratively to achieve project goals and objectives with the help of their respective planning and administrative support resources.

For the carrying out of PMT function the PMT has no delegated authority from the client to approve or bind. The PMT may agree in principle planning and delivery aspects of the project but only the client has the authority to agree, approve or bind. This separation of power is important for establishing probity and good governance. The control of the project rests with the client thus ensuing influence in all planning and delivery matters under the HA and future Project Orders. Gateway reviews under the HA are carried out by the client as are all matters relating to project variations under the PO. The client may delegate this responsibility to an individual from time to time subject to appropriate notice.

The HA is a planning tool designed to support the strategic procurement process by better analysis and implementation of a portfolio of projects rather than piece-meal. The HA is not a vehicle for the delivery of projects. A project that has successfully completed the planning requirements of the HA will be implemented by the Partner following the execution of a Project Order (PO). The PO is a stand-alone legal instrument that fully defines all aspect of the project's administration, legal, commercial and scope requirements. In the event that the MA is terminated the PO survives until it either terminated in accordance with the term and conditions, by agreement or comes to an end.

In FIG. 4 above the area commencing from the entry of the portfolio of works through to the partner's submission of an offer is a zone of intense collaboration. The extent of the collaboration and type of relationship between the parties is agreed in the project charter. The project charter's purpose is to describe how the parties are to behave and co operation during the planning and delivery phases of the project. It is the intention of the party's teams to work closely together on all aspects of the planning phase. This approach will ensure no surprises and result that best matches the client's needs. At no time will the partner be isolated from the client's team of technical, planning and operational staff. This arrangement will ensure that the best information and any modification to the process is supported by both teams.

The Project charter is an annexure, to and a requirement of the HA. The purpose of the charter is to define the aim and vision of the team, the project objectives and the behaviour expected between the parties during implementation. This is established early in the project and checked at various intervals during the implementation of the HA. In the event the relationship is found to be wanting step will be taken to remedy problem.

The reporting requirements of the HA are comprehensive. Reports shall be prepared by the partner in collaboration with the client's team and provided to the PET. The report will include an update of portfolio planning progress and a snap shot of all PO's performance. As well as this the partner will provide at regular intervals raw commercial data on all POs to the PMT. The PMT will analyse this data and use it to monitor, independently of the partner, the progress and performance of each PO. Where it is found that PO's performance is not up to expectations this information will be used in future portfolio planning activities. These activities include project description, project proposal amendments and master plan changes. Fundamental to the implementation of the HA or AIP Model is the need for good communication and no surprises during the planning and delivery phases.

Critical to the success of the strategic planning process is the role of the client's project Manager. Early in the planning phase the client will identify a project Manager for the planning and delivery phase of the project. The project Manager will be responsible for carrying out all clients' internal activities of reporting and project development as well as being the conduit through which all projects enter the PMT or go to the client's gateway review group for consideration and where necessary approval.

The project Manager (PM) is responsible for the assessment of the Project Proposal (the Offer). This assessment will accept or reject the Partner's recommendation based on the information provided in the Client's submission. When the PM has formed the view that the offer should be accepted he will present his findings and recommendation to the client. If the client concurs with the'findings of the PM the client will prepare and execute a project order for the project's delivery. During the delivery phase the PM will assist with the delivery of the Project for the client according to the PO terms and conditions.

An offer if accepted by the Client or his delegated authority will be the basis of the PO for the delivery of the work. The PO is an independent stand alone document that has no relationship with the HA and which will survive the termination of the HA. The PO will include all related terms and conditions of the contract, the general conditions and special conditions of contract, administrative requirements, commercial arrangements, the scope of works and specifications all of which are essential elements for development of the contract.

If an Offer is rejected for any reason the client may seek a quote from a third party. According to the HA the parties agree that the client has the right to reject an offer if of the opinion that it has not met any of its needs, the principles of procurement or any condition agreed to in the procurement plan. In rejecting the offer the client has no liability for the costs incurred by the partner in the planning phase through the engagement of partner's resources. The identification of a third party and the subsequent preparation of a Request for Tender will be the responsibility of the client. To mitigate the risk of an offer being rejected the parties agree to work collaboratively on the submission to ensure that all aspects of the client's needs are considered and allowed for in the offer.

The client may during the assessment of the offer find there are issues or questions arising from the content of the submission. To address these issues the partner will be given the option to modify the submission or withdraw and resubmit with requested changes for re-assessment. The notice to modify and the response from the partner will be formal and subject to strict time provisions.

Following the client assessment and approval of an offer the client's representative will commence the approval process. The project approval process is an activity within the client's organisation which involves the execution of a PO or contract, the allocation of funds and the allocation of delivery resources. The approval shall be executed by the client or the client's delegated authority for the future project delivery.

The legal style and content of the PO will be proposed by the partner in collaboration with the client's team involved in the planning phase. The partner has the freedom to choose the type of instrument and its application providing it is in a form acceptable to the client. By working collaboratively the parties mitigate the chance of the legal form being rejected. The needs of each project will be considered on merit and a contract form matching the projects risk profile and uncertainty will be included with the offer.

The role of client during the delivery of a project is business as usual. This means that the administrative obligations of the client in the PO for the management of internal and externally functions arising from the contract will be similar to what has happened on similar projects in the past. These obligations may require the engagement of PMs and Design Managers, Contract Managers and Inspectors for project delivery. The client or his delegated authority is the only persons with the authority to approve, direct and vary the contract.

The project delivered by the Partner on completion will be handed over to the client's operations staff or stakeholders. The handover and the responsibility of the parties for maintenance and future operations will be spelt out in the PO. For complex high risk projects the performance of the completed facility may not be known for several years after commissioning. The PO must contain a clear and accurate definition of the client's needs with respect to the facility's performance and technical specification. The PO must also contain details of the potential actions that will be taken in the event that the finished product does not meet design and operational requirements. The partner under the HA takes full responsibility of the PO outcomes. However each project's risks profile will be considered on its merit and by agreement maybe shared if that outcome is commercially more advantageous to the client.

The HA has extensive and stringent contract termination provisions. These provisions may be activated by the giving of notice by either party for a breach, the completion of the term or tasks or by agreement. The PO's are separate legal instruments between the client and the partner, which survives the HA's termination. For example POs executed in the last year of the HA term that extend beyond the remaining term of the HA will continue unaffected by the HA's termination.

In order to illustrate the differences between the method of the present invention, headed “AIP Model” and traditional procurement methodology, Table 1 is provided below. It can be seen that as the stages of a project are compared side-by-side, the method of the present invention provides for a no scope, no cost initial agreement in the planning stage of the project.

TABLE 1

| | |
|---|---|
| AIP Model ™ | Traditional |

LEGAL

| | | |
|---|---|---|
| AIP Model ™ | 1. This model plays in the | 1. Project specific |
| | program | planning/procurement |
| | planning/procurement | under a valued contract. |
| | space under a no | 2. The Client provides the |
| | scope/no value contract | planning/procurement |
| | arrangement. | resources at their cost. |
| | 2. The Partner provides the | 3. Usually no input on |
| | resources for the | planning, if Early |
| | planning/procurement | Contractor Involvement, |
| | under the no value | Contractor is engaged on |
| | arrangement. | a project specific basis. |
| | 3. Partner is engaged early | 4. If a Managing Contractor |
| | in the program planning | or Early Contractor |
| | stage. | Involvement (ECI), the |
| | 4. If a Project Order is | Contractor does not have |
| | executed for delivery, the | full responsibility over |
| | Partner has full | delivery. |
| | responsibility for delivery | |
| | of goods and services. | |
| AIP facilitates the | 1. Swift contract execution | 1. Take at least 52 weeks to |
| swift establishment of | | execute a contract. |
| the Head Contract in | | |
| up to 16 weeks. | | |
| Partner has tenure, | 1. Partner has an extended | 1. Contract is project |
| assurance and | term managing the | specific and concludes at |
| freedom. | Portfolio Works | completion of project. |
| | planning/procurement. | 2. Contractor does not assist |
| | 2. Partner has assurance that | with |
| | they will assist with the | planning/procurement. |
| | Portfolio Works | 3. Contractor is chosen |
| | planning/procurement. | using Client's |
| | 3. Partner has freedom to | knowledge, experience |
| | exercise their own market | and skills. |
| | knowledge, experience | |
| | and skills in the strategic | |
| | planning/procurement of | |
| | the Portfolio Works. This | |
| | therefore minimises | |
| | bureaucratic costs due to | |
| | the utilisation of the | |
| | Partner's tender process. | |
| | Alternatively, the Partner | |
| | has the freedom to | |
| | propose self performance | |
| | which is decided by the | |
| | Client on a value for | |
| | money basis. | |
| Potential for multiple | 1. Allows other Clients to | 1. One Client |
| clients and diversity | utilise the arrangement | 2. One Project or project |
| of projects | with Partner and add | type. |
| | Work Items to the | |
| | Portfolio Works | |
| | 2. Allows projects not | |
| | related to the original | |
| | portfolio to also be | |
| | included in the Portfolio | |
| | Works. | |

CONTRACT ADMINISTRATION

| | | |
|---|---|---|
| Strategic Approach | Use of a portfolio of projects for | Nonstrategic approach. |
| | the purpose of: | Approach is piecemeal with no |
| | developing synergies | portfolio of projects, no |
| | between the projects | synergies and no economies of |
| | enhancing portfolio | scale. |
| | delivery through better | |
| | choice of projects and | |
| | gaining efficiencies | |
| | through economies of | |
| | scale. | |
| Selection of a Partner | Partner selected following a | Contractor may be selected but |
| | competitive process, based on | paid for services rendered with a |
| | their capacity and capability to | known scope of work. Higher |
| | meet client's needs without | emphasis on commercial than |
| | scope being known. | non-commercial capability. |
| Services provided by | Partner provides planning, | Contractor does not provide |
| Partner under this | procurement, administrative and | these services as project by |
| arrangement | estimating resources necessary | project basis of delivery. |
| | for the implementation of the | |
| | planning and tendering process. | |
| Project definition | Partner when provided with the | Project definition provided by |
| | Portfolio Works will separate or | Client. |
| | bundle Work Items into projects | |
| | from which effectiveness and | |
| | efficiency gains may be realised. | |
| | The decision with respect to | |
| | project definition is based on the | |
| | Partner's market intelligence and | |
| | experience. | |
| Master Program | Partner will develop and keep up | Individual programs for projects |
| | to date a Master Program of all | defined by the client. |
| | portfolio projects. This will | |
| | included all administrative | |
| | planning, procurement and | |
| | delivery milestones. The cost of | |
| | providing these resources is | |
| | carried by the Partner. | |
| Procurement Plan | The Procurement Plan is the | Not a feature of traditional |
| | document prepared by the | contracts. |
| | Partner that describes how the | |
| | project is to be procured. This | |
| | document is prepared in | |
| | collaboration with Client but | |
| | includes a project description, | |
| | how it will meet Client's needs, | |
| | how it will meet | |
| | any required principles of | |
| | procurement and what form the | |
| | contract will take. The | |
| | Procurement Plan is subject to | |
| | the approval of the Client before | |
| | implementation. | |
| Project Proposal | The Project Proposal or offer is | Offer based on Client's tender. |
| | based on the Procurement Plan | |
| | prepared by the Partner. It is in | |
| | the form acceptable to the Client, | |
| | which addresses all the Client's | |
| | procurement and project needs | |
| Client's governance | Portfolio governance is achieved | Transparency may not be |
| | through the separation of power, | essential. |
| | full transparency and probity. | |
| | This ensures the Client retains | |
| | the power to bind or vary, no | |
| | hidden details and fair and | |
| | ethical behaviour | |
| Collaboration between | Parties to the contract form two | Not present in traditional |
| the parties. | management teams for | arrangement. |
| | administration of the program. | |
| | The operation team is the | |
| | Portfolio Management Team | |
| | (PMT) and the strategic team is | |
| | the Portfolio Executive Team | |
| | (PET). At all levels the team and | |
| | support resources work together | |
| | collaboratively to ensure the best | |
| | results without any surprises. | |
| Risk analysis and | Prior to the execution of a | Usually prescribed by Client |
| assessment | Project Order each project's risk | |
| | is assessed on its merit and the | |
| | mitigation strategy decided by | |
| | the parties collaboratively. | |
| Administration | PET has advisory role and | No applicable |
| structure | dispute resolution function where | |
| | as the PMT are responsible for | |
| | agreeing in principle all | |
| | deliverables from the planning | |
| | process. | |
| AIS management | A comprehensive computer | Not applicable as usually in- |
| system | based project management | house system |
| | system that collects, analyses and | |
| | disseminates data from the | |
| | planning and delivery phases of | |
| | the project. | |
| Discipline in | The management system is | Non to limited discipline |
| management system | designed to force parties to | required by agreements by |
| | submit data into the system and | Partner. |
| | on the way develop a discipline | |
| | that ensure timely, accurate and | |
| | relevant information for | |
| | recording and reporting | |
| | purposes. | |
| Data flow and | The HA provides for the future | Not provided as usually |
| collection analysis | transfer of project raw data from | protected by the Contractor. |
| | PO by the Partner. This raw data | |
| | will be analysis by the Client for | |
| | determination of performance. | |
| Reporting | The HA provides for the future | Reports relate to a contractual |
| requirements | transfer of project information | obligation limited to that |
| | from PO by the Partner. This | contract. it is unusual that an |
| | Project information will be in the | obligation arises for reports to be |
| | form of project reports designed | prepared under for alternate |
| | to keep the cCient up to date | contractual obligation. |
| | with project performance and | |
| | progress. | |
| AIS has developed | The AIS comprehensive | Not applicable |
| platforms and | computer based project | |
| templates | management system collects, | |
| | analyses and disseminates data | |
| | from the planning and delivery | |
| | phases of the project, using data | |
| | templates specifically designed | |
| | for the purpose of our integrated | |
| | management system, which is | |
| | based on proprietary products. | |
| Gateway | Arising from the HA is the need | May be included usually post |
| Reviews/Peer reviews | for various steps in the planning | contract execution stage. |
| | phase to be subject to the | |
| | Client's review. This will be in | |
| | the form of either a Gateway | |
| | Review by the Client or a peer | |
| | review by independent persons. | |
| | The review is to ensure all | |
| | aspects of the projects | |
| | development and implementation | |
| | is the best possible outcome for | |
| | the Client. Review team is | |
| | independent of the project team, | |
| | reports to the Client and is | |
| | engaged prior to execution of the | |
| | PO. | |
| Partner fully | During the implementation of the | Normally defined and provided |
| responsible for | HA the Partner is fully | by Client. |
| resourcing level | responsible for providing the | |
| | quality and extent of planning, | |
| | administration and estimating | |
| | resources. | |
| Quality of submission | The quality of all submissions in | Quality responsibility of the |
| the responsibility of | response to projects is the | Client. |
| the Partner | responsibility of the Partner. | |
| | Submissions that are poor in | |
| | quality will reduce the | |
| | probability of the submission | |
| | being accepted or approved by | |
| | the Client. Whereas submissions | |
| | of high quality will increase the | |
| | probability of the submission | |
| | being approved or accepted by | |
| | the Client. | |
| No best for project | Project deliverables shall be | Best for project issues are |
| issues with respect to | based on analysis of current | common place in alliance |
| quality and operations | Client situation and stakeholder | contracts and generally result in |
| | needs. All best for project | detrimental attitudes in contract |
| | decision will be reviewed by the | implementation. |
| | Client prior to implementation in | |
| | the PO to ensure all aspects of | |
| | desired change are in the best | |
| | interest of the Client. All best for | |
| | project recommendation shall be | |
| | included in the Procurement Plan | |
| | for consideration and comment. | |
| Strategic Approach | Use of a portfolio of projects for | Nonstrategic approach. |
| | the purpose of: | Approach is piecemeal with no |
| | developing synergies | portfolio of projects, no |
| | between the projects | synergies and no economies of |
| | enhancing portfolio | scale. |
| | delivery through better | |
| | choice of projects and | |
| | gaining efficiencies | |
| | through economies of | |
| | scale. | |
| Selection of a Partner | Partner selected following a | Contractor may be selected but |
| | competitive process, based on | paid for services rendered with a |
| | their capacity and capability to | known scope of work. Higher |
| | meet client's needs without | emphasis on commercial than |
| | scope being known. | non-commercial capability. |
| Services provided by | Partner provides planning, | Contractor does not provide |
| Partner under this | procurement, administrative and | these services as project by |
| arrangement | estimating resources necessary | project basis of delivery. |
| | for the implementation of the | |
| | planning and tendering process. | |
| Project definition | Partner when provided with the | Project definition provided by |
| | Portfolio Works will separate or | Client. |
| | bundle Work Items into projects | |
| | from which effectiveness and | |
| | efficiency gains may be realised. | |
| | The decision with respect to | |
| | project definition is based on the | |
| | Partner's market intelligence and | |
| | experience. | |

COMMERCIAL ARRANGEMENT

| | | |
|---|---|---|
| Agreed fee | An agreed fee is stated in the HA | Fee may be applied generally |
| | for application to future Project | only when scope is known and |
| | Orders independent and separate | the extent of work is defined. |
| | from the HA, for the recovery of | |
| | the cost of providing resources | |
| | under the HA. This fee is agreed | |
| | prior to the scope of work being | |
| | established. The fee is fixed for | |
| | the term of the contract. | |
| No payment for | All services provided under the | All resources are paid for by the |
| services provided | HA are provided by the Partner | Client. |
| under HA | without charge. In the event that | |
| | a Project Order is raised a fee | |
| | will be applied to the direct costs | |
| | for the Partner to recover the cost | |
| | of providing planning resources. | |
| | There is no certainty over the | |
| | breadth and depth of scope of | |
| | work in the Portfolio Works. | |
| Recovery of service | Project Proposals accepted by the | Not applicable. However may |
| costs via future | Client will be converted to a | exist under alliance arrangements |
| project orders | Project Order for execution by | coupled with gainshare and |
| | the parties. The Partner will | painshare provisions. |
| | apply the agreed fee to the | |
| | project direct costs in order to | |
| | recover corporate overheads and | |
| | profit. Included in this fee is the | |
| | cost of recovering project | |
| | planning resources provided to | |
| | meet HA obligations. | |
| Client's control | The Client has control and the | Limited authority prior to |
| | authority to approve all aspects | execution of contract. |
| | of the administrative process in | |
| | the planning phase. | |
| Client's savings | Client savings are identified | Project efficiencies are limited to |
| | collaboratively by the parties in | the request for tender process |
| | the planning phase and realised | and are not significant savings |
| | in the delivery phase of the | from procurement/planning and |
| | portfolio of works, prior to the | delivery. |
| | execution of the project. | |
| Partner appointed | The Partner is selected following | Scope and value known and |
| following a | a competitive process based on | tender is encouraged to provide a |
| competitive tender | capacity, capability and mark up | price for the work. |
| process | for corporate overhead and | |
| | profit. The Tender has no | |
| | representation of scope or value | |
| Offer competitive | The Partner seeks prices from | Not an issue considered by |
| tension from | subcontractors and consultants | Client normally non transparent |
| subcontractor and | when preparing Project | and the responsibility of the |
| consultants | Proposals or offers. It is up to the | Contractor. |
| | Partner to encourage | |
| | participation of subcontractor | |
| | and consultants to ensure | |
| | competitive tension in the prices | |
| | for goods and services. | |
| Partner provides | Partner provides all core business | All resources provided by |
| resources for planning | resources (planning, | Contractor are at an agreed rate. |
| process | administrative, estimation and | |
| | tendering associated with the | |
| | portfolio of work delivery) | |
| | without charge. In the event that | |
| | a Project Order is raised a fee | |
| | will be applied to the direct costs | |
| | for the Partner to recover the cost | |
| | of providing planning resources. | |
| No hidden bucket of | The HA has no budget and no | Will have a budget. |
| money | provision to pay any claims from | |
| | the Partner. All payments for | |
| | projects are via a Project Order. | |
| Time saving at | Time saved on establishing the | Opportunity does not exist. |
| initiation translate to | Head Agreement (in government | |
| earlier revenue stream | organisation up to 1 yr and the | |
| | time saved during the tender | |
| | process of on average 6 months) | |
| | will bring infrastructure projects | |
| | on line approximately 18 months | |
| | earlier than traditional delivery. | |
| | This social and financial benefit | |
| | will be realised in community | |
| | support and earlier revenue from | |
| | the facility respectively. | |
| Potential for reduced | The Head Agreement makes | Limited opportunity to change. |
| fees for successful | provision for the Partner to | The process is managed by the |
| program | reduce fees in the event that | Client. |
| | corporate overhead and profit are | |
| | excessively over-recovered from | |
| | approved projects. The process is | |
| | managed by the Partner. | |
| Use of Partner | Resources provided by the | Client must pay for all resources |
| resources defers | Partner for the planning, | on a needs basis. |
| Client's | administration, estimating and | |
| administrative costs | tendering process are resources | |
| | the Client is not required to | |
| | provide. This results in budget | |
| | savings for the Client and | |
| | deferred payment for resource | |
| | costs via future Project Orders. | |

SCOPE OF WORK.

| | | |
|---|---|---|
| No scope/no value | 1. No scope means that the | 1. A traditional, project |
| Head Agreement | Partner is not guaranteed | specific contract has a |
| | any work. No value | scope and value. Also, an |
| | means that the Partner is | ECI, Managing |
| | not guaranteed any | contractor or alliance |
| | payment. | model also has a scope |
| | 2. The Client is not | and/or value. |
| | obligated to contract with | 2. The Client is obligated to |
| | the Partner for the works. | deliver the works with |
| | The Client can go to a | the Contractor and does |
| | third party if preferred. | not have the option to go |
| | 3. Client therefore has | with a third party. |
| | constant control and | 3. Client does not have the |
| | monitoring power. This | control and interaction |
| | enables fully detailed | with Contractor as bound |
| | offers on individual | by the terms and |
| | projects due to | conditions of the delivery |
| | collaboration. | contract. |
| Portfolio of works | 1. A Portfolio of Works is | 1. Traditional methods are |
| | provided to the Partner | project based and not |
| | on an annual basis with | portfolio based. |
| | the opportunity to add (or | |
| | take from) to the | |
| | Portfolio Work | |
| | throughout the year. | |

In consequence of the adoption of the method of the present invention, other issues normally considered in the completion of a project will require reconsideration. For example, insofar as funding of projects is concerned, it is to be appreciated that Capital Funding is an essential element of a project's consideration during the client's planning and feasibility phases. Depending on the type of project being considered, short or long term funding may be provided by way of debt finance or seeking an equity partner. If the client chooses engage an equity partner it will be subject to projects risk profile, the security provided for the investment and the revenue stream features. As well as this a funding model needs to be developed to allow or to not separate the infrastructure from the client's business and to develop the associated provisions for the collection of revenue and operation and maintenance after construction is completed. To date the funding for infrastructure projects has been provided by the client. However if the need arises a model of funding will be developed in collaboration with the equity partner and the client thus ensuing an alignment of parties interests.

A tentative proposal for funding is exemplified as follows: A government is in the process of rationalising supply of an essential utility in its jurisdiction. This could, for example, result in the transfer of major assets from government ownership to a new entity, established for the purpose of such rationalisation. The net effect of this change is some major assets will be owned and operated by the government while others will be owned and operated by the new entity.

Responsibility for the administration of government operation or retail assets will be rest with government, however responsibility for the operations of major assets will rest with the manager and the new entity. Therefore funding for any project may be provided for an asset whose ownership may be shared between Entity asset and government assets.

For example, what is apparent at the local government level in south-east Queensland is that the demand for infrastructure is growing and currently the state government is heavily committed to existing infrastructure projects and it is reasonable for shortfalls to occur in local government funding.

One funding model is that of public, private partnerships (PPP's) to supplement investment funding shortfalls. Such a funding facility would have to satisfy conditions such as the following
What security will be provided to secure debt?
What is the capacity of the borrower to repay loan?
What is the credibility of the borrow?

The degree of comfort will be reflected in the risk profile, the rate and the conditions of the funding instrument. Providing these are attractive it will lead to development of secure investment opportunity for the lending institution.

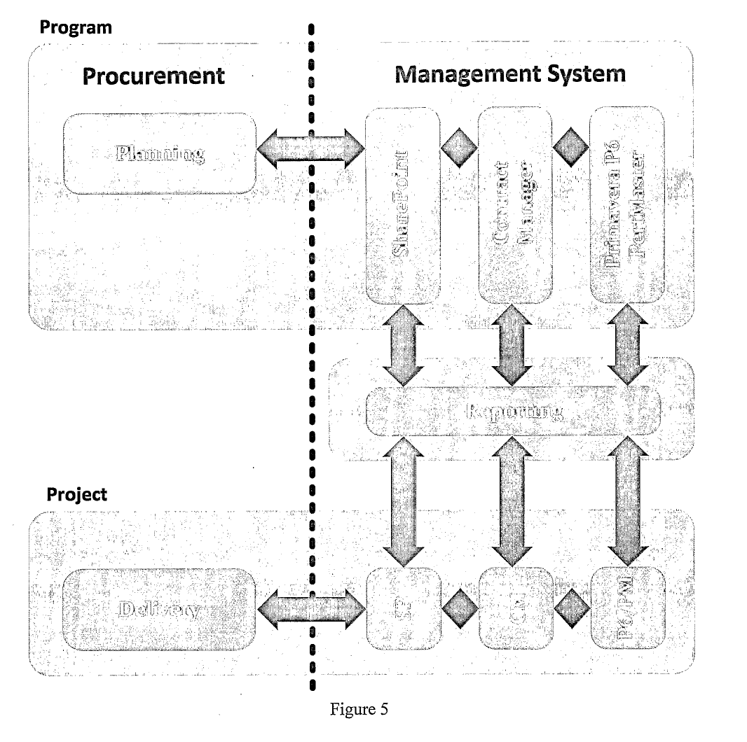

The management system diagram of FIG. 5 illustrates that the flow of management information is through a central location in the “reporting” section of the diagram. It can be seen that management information from both the procurement stage and the project stage is directed to “reporting” as a central location. Project partners would have to relax their normal restrictions on access to their raw management data. However, the benefits of the method will accrue in respect of continued work and remuneration in respect of same benefitting not only the project partners, but also the client and their constituents.

In use, it can be seen that the method affords several benefits, including, but not limited to a swift contract execution, confidence in selection for completion of the project and efficiencies gained through the shifting of the active decision making to the commercial partner and the elimination of “red tape”. Preferably, the project partner has an extended term managing a portfolio works planning and procurement, whereby the project partner has assurance that they will assist with the portfolio works planning and procurement.

The Project partner has freedom to exercise their own market knowledge, experience and skills in the strategic planning and procurement of the Portfolio Works. This therefore minimizes bureaucratic costs due to the utilisation of the Project partner's tender process. Alternatively, the Project partner has the freedom to propose self performance which is decided by the Client on a value for money basis.

The method of the present invention allows other clients to utilise the arrangement with project partner and add work items to the portfolio works. The method also allows projects not related to the original portfolio to be included in the Portfolio Works.

The method of the present invention allows use of a portfolio of projects for the purpose of developing synergies between the projects, enhancing portfolio delivery through better choice of projects and gaining efficiencies through economies of scale.

The project partner is preferably selected following a competitive process, based on the capacity and capability of each to meet the client's needs without scope being known. The project partner provides planning, procurement, administrative and estimating resources necessary for the implementation of the planning and tendering process.

The project partner, when provided with the Portfolio Works, will separate or bundle Work Items into projects from which effectiveness and efficiency gains may be realised. The decision with respect to project definition is based on the Project partner's market intelligence and experience.

Project partner will develop and keep up to date a Master Program of all portfolio projects. This will included all administrative planning, procurement and delivery milestones. The cost of providing these resources is carried by the Project partner.

The Procurement Plan is the document prepared by the Project partner that describes how the project is to be procured. This document is prepared in collaboration with Client but includes a project description, how it will meet Client's needs, how it will meet any required principles of procurement and what form the contract will take. The Procurement Plan is subject to the approval of the Client before implementation.

The Project Proposal or offer is based on the Procurement Plan prepared by the Project partner. It is in the form acceptable to the Client, which addresses all the Client's procurement and project needs.

Portfolio governance is achieved through the separation of power, full transparency and probity. This ensures the client retains the power to bind or vary, no hidden details and fair and ethical behaviour.

Parties to the contract form two management teams for administration of the program. The operation team is the Portfolio Management Team (PMT) and the strategic team is the Portfolio Executive Team (PET). At all levels the team and support resources work together collaboratively to ensure the best results without any surprises.

Prior to the execution of a Project Order each project's risk is assessed on its merit and the mitigation strategy decided by the parties collaboratively.

PET has advisory role and dispute resolution function where as the PMT are responsible for agreeing in principle all deliverables from the planning process.

A comprehensive computer based project management system that collects, analyses and disseminates data from the planning and delivery phases of the project.

The management system is designed to force parties to submit data into the system and on the way develop a discipline that ensure timely, accurate and relevant information for recording and reporting purposes.

The HA provides for the future transfer of project raw data from PO by the Project partner. This raw data will be analysis by the Client for determination of performance.

The HA provides for the future transfer of project information from PO by the Project partner. This Project information will be in the form of project reports designed to keep the client up to date with project performance and progress.

The AIS comprehensive computer based project management system collects, analyses and disseminates data from the planning and delivery phases of the project, using data templates specifically designed for the purpose of our integrated management system, which is based on proprietary products.

Arising from the HA is the need for various steps in the planning phase to be subject to the Client's review. This will be in the form of either a Gateway Review by the Client or a peer review by independent persons. The review is to ensure all aspects of the projects development and implementation is the best possible outcome for the Client. Review team is independent of the project team, reports to the Client and is engaged prior to execution of the PO.

During the implementation of the HA the Project partner is fully responsible for providing the quality and extent of planning, administration and estimating resources.

The quality of all submissions in response to projects is the responsibility of the Project partner. Submissions that are poor in quality will reduce the probability of the submission being accepted or approved by the Client. Whereas submissions of high quality will increase the probability of the submission being approved or accepted by the Client.

Project deliverables shall be based on analysis of current Client situation and stakeholder needs. All best for project decision will be reviewed by the Client prior to implementation in the PO to ensure all aspects of desired change are in the best interest of the Client. All best for project recommendation shall be included in the Procurement Plan for consideration and comment.

Use of a portfolio of projects for the purpose of: developing synergies between the projects, enhancing portfolio delivery through better choice of projects and gaining efficiencies through economies of scale. A Project partner is selected following a competitive process, based on each potential Project partner's capacity and capability to meet the client's needs without the scope of the project being known. The Project partner provides planning, procurement, administrative and estimating resources necessary for the implementation of the planning and tendering process.

The Project partner, when provided with the Portfolio Works, will separate or bundle Work Items into projects from which effectiveness and efficiency gains may be realised. The decision with respect to project definition is based on the Project partner's market intelligence and experience.

An agreed fee is stated in a Head Agreement (HA) for application to future Project Orders independent and separate from the HA, for the recovery of the cost of providing resources under the HA. This fee is agreed prior to the scope of work being established. The fee is fixed for the term of the contract.

All services provided under the HA are provided by the Project partner without charge. In the event that a Project Order is raised a fee will be applied to the direct costs for the Project partner to recover the cost of providing planning resources. There is no certainty over the breadth and depth of scope of work in the Portfolio Works.

Project Proposals accepted by the Client will be converted to a Project Order for execution by the parties. The Project partner will apply the agreed fee to the project direct costs in order to recover corporate overheads and profit. Included in this fee is the cost of recovering project planning resources provided to meet HA obligations.

The Client has control and the authority to approve all aspects of the administrative process in the planning phase.

Client savings are identified collaboratively by the parties in the planning phase and realized in the delivery phase of the portfolio of works, prior to the execution of the project.

The Project partner is selected following a competitive process based on capacity, capability and mark up for corporate overhead and profit. The Tender has no representation of scope or value

The Project partner seeks prices from subcontractors and consultants when preparing Project Proposals or offers. It is up to the Project partner to encourage participation of subcontractor and consultants to ensure competitive tension in the prices for goods and services.

Project partner provides all core business resources (planning, administrative, estimation and tendering associated with the portfolio of work delivery) without charge. In the event that a Project Order is raised a fee will be applied to the direct costs for the Project partner to recover the cost of providing planning resources.

The Head Agreement has no budget and no provision to pay any claims from the Project partner. All payments for projects are via a Project Order. Time saved on establishing the Head Agreement (in government organisations up to 1 yr and the time saved during the tender process of on average 6 months) will bring infrastructure projects on line approximately 18 months earlier than traditional delivery methods. This social and financial benefit will be realised in both community support and earlier revenue from the facility.

The Head Agreement makes provision for the Project partner to reduce fees in the event that corporate overhead and profit are excessively over-recovered from approved projects. The process is managed by the Project partner. Resources provided by the Project partner for the planning, administration, estimating and tendering process are resources the Client is not required to provide. This results in budget savings for the Client and deferred payment for resource costs via future Project Orders.

Insofar as scope of work is concerned, “no scope” means that the Project partner is not guaranteed any work. “No value” means that the Project partner is not guaranteed any payment. The Client is not obliged to contract with the Project partner for the works. The Client can go to a third party if preferred. The Client therefore has constant control and monitoring power. This enables fully detailed offers on individual projects due to collaboration. A Portfolio of Works is provided to the Project partner on an annual basis with the opportunity to add (or take from) to the Portfolio Work throughout the year.

The foregoing description has been given by way of illustrative example of the invention and many modifications and variations, which will be apparent to persons skilled in the art maybe made without departing from the ambit, spirit and scope of the invention as defined by the appended claims.

What is claimed is:

1. A method of procurement for a procurement Client comprising the steps of:
assessing one or more needs whereby a supply is to be procured on behalf of the procurement Client;
tendering for satisfaction of the supply for a predetermined proportion or margin of a figure associated with the supply by one or more project partners; and
selecting the one or more project partners for procuring the supply on behalf of the procurement Client as a selected project partner;
entering first Particulars of the supply to be procured the predetermined proportion or martin and the one or more project partners into a database operable on a computer; and
having the selected project partner, completing the procurement of the supply for delivery and/or handover to the procurement Client by operation of a database management program operable on the computer.

2. A method of procurement for a procurement Client comprising the steps of:
assessing one or more needs whereby a supply is to be procured on behalf of the procurement Client;
tendering for satisfaction of the supply for a predetermined proportion or margin of a figure associated with the supply by one or more project partners;
contracting the one or more project partners for procuring the supply on behalf of the procurement Client as a selected project partner with a contract having no scope and no value;
entering first particulars of the supply to be procured the predetermined portion or margin, and the one or more project partners into a database operable on a computer; and
having the selected project partner, completing procurement of the supply for delivery and/or handover to the procurement Client by operation of a database management program operable on the computer.

3. A method of procurement in a program planning procurement stage of a project by a project partner for a procurement Client comprising the steps of:
establishing a no scope, no value contract arrangement between the procurement Client and the project partner;
providing of resources by the project partner for the planning procurement stage under the no value arrangement;
engaging the project partner in the program planning stage;
entering second particulars of the contract arrangement, provision of resources and engagement of the project into a database operable on a computer; and
upon the execution of a project order, conferring full responsibility for delivery of goods and services to the project partner by operation of a database management program operable on the computer.

4. The method according to claim 1 or claim 2, wherein assessing of the one or more needs is carried out by the procurement Client.

5. The method according to claim 1, further comprising the step of completing a feasibility study prior to tendering.

6. The method according to claim 1, further comprising the step of completing a concept design step prior to tendering.

7. The method according to claim 1, wherein a predetermined proportion or margin is assessed on the value of one or more work orders contracted by a contractor to the project partner.

8. A computerized method of procurement for a procurement Client comprising the steps of:
providing a database operable on a computer;
providing a management program operable on the computer for managing data entered into the database, the management program including a selection phase and an operational phase;
entering first particulars of a supply to be procured on behalf of the procurement Client into said database;
entering second particulars of one or more project partners into said database, said second particulars comprising capability and capacity of the one or more project partners to provide the supply;
entering a proportion or margin of a figure associated with the supply into said database in respect of said supply for the one or more project partners;
entering third particulars of one or more facilitators familiar with the requirements of the supply to be procured for the procurement Client;
operating the selection phase of the management program to select one or more project partners tendering for satisfaction of the supply, based on the proportion or margin based on a contract having no scope and no value, the project partner selection being based on their capability and capacity to exceed procurement Client's needs with respect to planning and delivery of the supply, whereupon the one or more project partners is matched to one or more facilitators; and
operating the operational phase of the management program by first entering the administrative responsibility and commercial arrangements for the one or more facilitators into the database, dividing roles and responsibilities of the one or more facilitators, the procurement Client, and the one or more project partners for a Setup phase and an Operations Phase, tagging entries in the database for allocation to a Procurement Process, a Management system and Capital Funding management system with the management program to complete the procurement of said supply for delivery and/or handover to the procurement Client.

9. The computerized method according to claim 8, wherein the database management program is operated by the one or more project partners.

10. The computerized method according to claim 11, further comprising the step of providing of resources by the one or more project partners for a planning procurement stage under the no value arrangement of the contract.

11. The computerized method according to claim 8, wherein assessment of the one or more needs is carried out by the procurement Client by accessing information provided to the database by the one or more project partners.

12. The computerized method according to claim 8, wherein the management database management program comprises a reporting section for reporting information to the procurement Client and the one or more project partners, and the method further comprises the step of restricting the flow of management information through a central location in the reporting section whereby management information from both a procurement stage and a project stage of said supply is directed to said reporting section as a central location.
